(19) United States
(12) Patent Application Publication
(10) Pub. No.: US 2016/0095311 A1
(43) Pub. Date: Apr. 7, 2016

(54) GEL FORMULATIONS FOR EXTENDED RELEASE OF VOLATILE COMPOUNDS

(71) Applicants: Fujun LU, Shanghai (CN); Tong SUN, Shanghai (CN); jiguang ZHANG, Shanghai (CN); Quingshan Jason NIU, Excelsior, MN (US); Wei LI, Shanghai (CN); Xiuhan Grace YANG, Shanghai (CN); Bruce Alan MENNING, Midland, MI (US); Christian Guy BECKER, King of Prussia, PA (US); Richard Martin JACOBSON, Chalfont, PA (US); AGROFRESH INC., Spring House, PA (US)

(72) Inventors: Fujun LU, Shanghai (CN); Tong SUN, Shanghai (CN); Jiguang ZHANG, Shanghai (CN); Qingshan Jason NIU, Excelsior, MN (US); Wei LI, Shanghai (CN); Xiuhan Grace YANG, Shanghai (CN); Bruce Alan MENNING, Midland, MI (US); Christian Guy BECKER, King of Prussia, PA (US); Richard Martin JACOBSON, Chalfont, PA (US)

(21) Appl. No.: 14/786,734

(22) PCT Filed: Apr. 26, 2013
(86) PCT No.: PCT/CN2013/074816

§ 371 Date: Oct. 23, 2015

(51) Int. Cl. A01N 27/00; A01N 3/00; A01N 25/04

(52) U.S. Cl. CPC A01N 27/00; A01N 25/04; A01N 3/00

(57) ABSTRACT

Disclosed are packing material/matrix and methods of making thereof for slow or extended release of at least one active volatile compound(s). Provided are gel matrix polymerized from particular pre-polymer, and optionally initiators are added during polymerization. The active volatile compounds are encapsulated in molecular encapsulating agents into a form of molecular complex, an the molecular complex is further incorporated into the gel matrix. Also provided are methods for preparing the gel matrix and using thereof.

### BACKGROUND

Ethylene is an important regulator for the growth, development, senescence, and environmental stress of plants; mainly affecting related processes of plant ripening, flower senescence, and leaf abscission. Ethylene is usually generated in large amounts during growth of plants under environmental stress or during preservation and delivery of plants. Therefore yield of plants such as fruit and crop can be reduced under heat or drought stress before harvesting. The commercial value of fresh plants such as vegetables, fruits and flowers after harvesting is reduced by excessive ethylene gas which hastens the ripening of fruits, the senescence of flowers and the early abscission of leaves.

To prevent the adverse effects of ethylene, 1-methylcyclopropene (1-MCP) is used to occupy ethylene receptors and therefore inhibiting ethylene from binding and eliciting action. The affinity of 1-MCP for the receptor is greater than that of ethylene for the receptor. 1-MCP also influences biosynthesis in some species through feedback inhibition. Thus, 1-MCP is widely used for freshness retention post-harvest and plant protection pre-harvest.

But 1-MCP is difficult to handle because it is gas with high chemical activity. To address this problem, 1-MCP gas has been encapsulated successfully by oil-in-water emulsion with 1-MCP gas dissolved in internal oil phase, but the 1-MCP concentration in final product is low (<50 ppm).

Although 1-MCP is an effective ethylene inhibitor to extend the shelf-life of fruit and vegetable by interfering ethylene binding process at the receptor sites, it may only protect floral organs of some species (e.g. Chamelaucium uncinatum Schauer, Pelargonium peltatum L.) against ethylene for 48 to 96 hours. The plant will be sensitive to ethylene again after that, because new ethylene receptors will be generated again. Retreating with 1-MCP is required, but it is not convenient during export handling. Thus, there remains a need for a delivery system for extending the release of volatile compounds including 1-MCP.

### SUMMARY OF INVENTION

The present invention relates to packaging material/matrix and methods of making such packaging material/matrix for slow or extended release of at least one active volatile compound(s). Provided are gel matrix polymerized from particular pre-polymer, and optionally initiators are added during polymerization. The active volatile compounds are encapsulated in molecular encapsulating agents into a form of molecular complex, and the molecular complex is further incorporated into the gel matrix provide herein. Also provided are methods for preparing such gel matrix and methods for using such gel matrix.

In one aspect, provided is a method of preparing a gel matrix/packaging material. The method comprises:

(a) providing an active component comprising a molecular complex of an active volatile compound; and
(b) generating a polymerizable pre-polymer by cross-linking ethylenic unsaturated groups for encapsulating the active component of (a), thereby resulting a matrix with encapsulated active component; and;
wherein extended release of the active volatile compound is achieved upon contact of a solvent (for example water or water vapor) as compared to a control molecular complex without encapsulated in the matrix.

In one embodiment, the active volatile compound comprises a cyclopropene compound and the molecular complex comprises the cyclopropene compound encapsulated by a molecular encapsulating agent. In a further embodiment, the cyclopropene compound is of the formula:

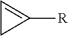

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

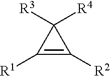

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen. In another embodiment, the cyclopropene compound comprises 1-methylcyclopropene (1-MCP).

In one embodiment, the molecular encapsulating agent of any of the above-described embodiments comprises alpha-cyclodextrin, beta-cyclodextrin, gamma-cyclodextrin, or combinations thereof. In another embodiment, the molecular encapsulating agent comprises alpha-cyclodextrin.

In one embodiment, the method further comprises adding at least one absorbent polymer to the matrix. In a further embodiment, the absorbent polymer is selected from the group consisting of polyacrylic acid, polyacrylamide, copolymer of acrylic acid and maleic anhydride, and combinations thereof.

In another embodiment, the polymerizable pre-polymer comprises an acrylate modified polyol. In a further embodiment, the polymerizable pre-polymer comprises (meth)acrylic acid esterified polyols. In another embodiment, the polymerizable pre-polymer comprises polyether polyols. In another embodiment, the polyol is selected from the group consisting of poly(propylene glycols) (PPGs), polyethylene glycols (PEGs), and combinations thereof. In another embodiment, the polyol is modified using Acrylic acids (AA), methacrylic acids (MAA), or combinations thereof. In another embodiment, mole ratio of AA to polyol is between 1:1 and 30:1; between 3:1 and 20:1; or between 5:1 and 10:1. In another embodiment, ratio by weight of the active component to the acrylate modified polyol is between 0.05% and 25%; between 0.1% and 10%; or between 1% and 5%.

In one embodiment, the method further comprises adding at least one initiator before polymerization. In a further embodiment, the initiator is selected from the group consisting of azodiisobutyronitrile, diisopropyl peroxydicarbonate, 2′,2′-Azobis-(2,4-dimethylvaleronitrile), dicyclohexyl peroxydicarbonate, dimethyl 2,2′-(diazene-1,2-diyl)bis(2-methylpropanoate), and combinations thereof. In another embodiment, the solvent comprises water or moisture.

In one embodiment, the gel matrix/packaging material is polymerized with heat. In another embodiment, radiation is not used to polymerize the gel matrix/packaging material. In another embodiment, the gel matrix is casted onto an existing package film and then polymerized into gel to form a coating on the existing package film. In another embodiment, no existing package film is used and the pre-polymer is polymerized into gel without support of another package film/packaging material. In a further embodiment, the pre-polymer is polymerized into a packaging material without support of another package film/packaging material.

In one embodiment, loss of the active volatile compound during step (b) is less than 2%; less than 5%; less than 10%; less than 20%; or less than 25%. In another embodiment, loss of the active volatile compound during step (b) is between 0.1% and 25%; between 1% and 20%; between 1.5% and 10%; or between 2% and 5%.

In another aspect, provided is a packaging material/gel matrix prepared by the method disclosed herein. In another aspect, provided is the use of the gel matrix provided herein in the manufacture of a packaging material for delaying ripening of plants parts including fruits. In another aspect, provided is a method of treating plants or plant parts. The method comprises storing said plants or plant parts with the gel matrix/packaging material as described herein.

In another aspect, provided is a method for preparing slow release packaging material/gel matrix. The method comprises:

(a) generating acrylate modified polyols by reacting polyols with at least one hydroxyl group with acrylic acid (AA) or methacrylic acid (MAA);
(b) dispersing a molecular complex of an active volatile compound into the acrylate modified polyols, thereby forming a slurry of the molecular complex and the acrylate modified polyols; and
(c) polymerizing the slurry into a network matrix by heat or radiation;
wherein extended release of the active volatile compound is achieved upon contact of a solvent (for example water or water vapor) as compared to a control molecular complex without encapsulated in the matrix.

In one embodiment, the steps (b) and (c) are solvent-free. In another embodiment, the network matrix is in a gel form. In another embodiment, the heat is provided by incubation at a temperature between 45° C. and 100° C.; between 55° C. and 85° C.; or between 65° C. and 80° C. In a further embodiment, time of the incubation is from 2 hours to 48 hours; from 4 hours to 24 hours; or from 8 hours to 16 hours. In another embodiment, the radiation does not include ultraviolet (UV) light.

In one embodiment, the slurry is casted onto an existing package film and then polymerized into gel to form a coating on the existing package film. In another embodiment, no existing package film is used and the slurry is polymerized into gel without support of another package film/packaging material. In a further embodiment, the slurry is polymerized into a packaging material without support of another package film/packaging material.

In one embodiment, the active volatile compound comprises a cyclopropene compound and the molecular complex comprises the cyclopropene compound encapsulated by a molecular encapsulating agent. In a further embodiment, the cyclopropene compound is of the formula:

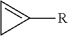

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

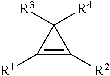

wherein R¹ is a substituted or unsubstituted C₁-C₄ alkyl, C₁-C₄ alkenyl, C₁-C₄ alkynyl, C₁-C₄ cycloalkyl, cycloalkylalkyl, phenyl, or napthyl group; and R², R³, and R⁴ are hydrogen. In another embodiment, the cyclopropene compound comprises 1-methylcyclopropene (1-MCP).

In one embodiment, the molecular encapsulating agent of any of the above-described embodiments comprises alpha-cyclodextrin, beta-cyclodextrin, gamma-cyclodextrin, or combinations thereof. In another embodiment, the molecular encapsulating agent comprises alpha-cyclodextrin.

In one embodiment, the method further comprises adding at least one absorbent polymer to the matrix. In a further embodiment, the absorbent polymer is selected from the group consisting of poly(vinyl alcohol) (PVA), polyacrylic acid, polyacrylamide, copolymer of acrylic acid and maleic anhydride (AA-MA copolymer), sodium poly(aspartic acid) (sPASp) and combinations thereof.

In another embodiment, the polyol is selected from the group consisting of polypropylene glycols) (PPGs), polyethylene glycols (PEGs), and combinations thereof. In another embodiment, the polyol is modified using Acrylic acids (AA), methacrylic acids (MAA), or combinations thereof. In another embodiment, mole ratio of AA to polyol is between 1:1 to 30:1; 3:1 to 20:1; or 5:1 to 10:1. In another embodiment, the ratio by weight of the active component to the acrylate modified polyol is between 0.05% to 25%; 0.1% to 10%; or 1% to 5%.

In one embodiment, the method further comprises adding at least one initiator before polymerization. In a further embodiment, the initiator is selected from the group consisting of azodiisobutyronitrile, diisopropyl peroxydicarbonate, 2′,2′-Azobis-(2,4-dimethylvaleronitrile), dicyclohexyl peroxydicarbonate, dimethyl 2,2′-(diazene-1,2-diyl)bis(2-methylpropanoate), and combinations thereof. In another embodiment, the solvent comprises water or moisture.

In one embodiment, loss of the active volatile compound during step (b) and/or (c) is less than 2%; less than 5%; less than 10%; less than 20%; or less than 25%. In another embodiment, loss of the active volatile compound during step (b) and/or (c) is between 0.1% and 25%; between 1% and 20%; between 1.5% and 10%; or between 2% and 5%.

In another aspect, provided is a packaging material/gel matrix prepared by the method disclosed herein. In another aspect, provided is the use of the gel matrix provided in the manufacture of a packaging material for delaying ripening of plants parts including fruits. In another aspect, provided is a method of treating plants or plant parts. The method comprises storing said plants or plant parts with the gel matrix/packaging material as described herein.

### BRIEF DESCRIPTION OF THE DRAWINGS

FIG. 1 shows a representative structure of acrylates modified Voranol 3322; m≧3, n≧3.

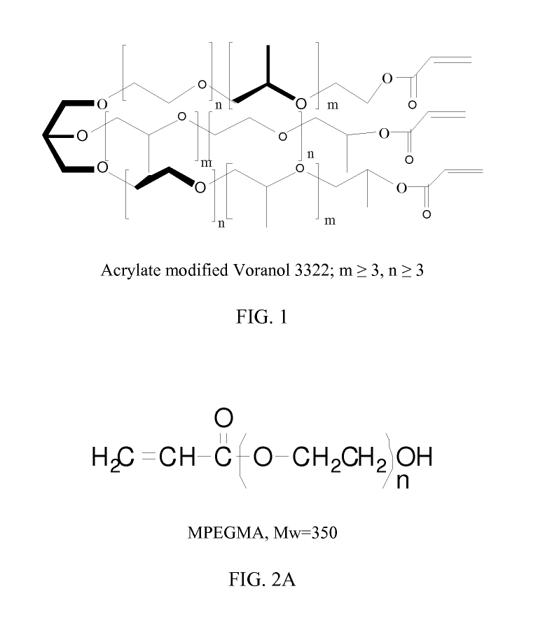

FIG. 2 shows various acrylate modified polyols which can be used as monomers for the present invention. FIG. 2A shows a representative structure of polyethylene glycol 350 monoacrylate (MPEGMA); FIG. 2B shows a representative structure of acrylate modified polyethylene glycol 400 (AM-PEG); and FIG. 2C shows a representative structure of acrylate modified Voranol RA 640 (AM-V640).

FIG. 3 shows various water absorbent polymers which can be used for the present invention. FIG. 3A shows structure of acrylic acid-maleic anhydride copolymer (AA-MA copolymer); FIG. 3B shows structure of sodium poly(aspartic acid) (sPASp); and FIG. 3C shows structure of poly(vinyl alcohol) (PVA).

FIG. 4 shows additional monomers or mixtures which can be used for the present invention.

FIG. 5 shows representative structures of initiators which can be used for the present invention.

### DETAILED DESCRIPTION OF THE INVENTION

The gas 1-methylcyclopropene (1-MCP) is a chemical that interferes with the ethylene receptor binding process. The affinity of 1-MCP for the receptors is greater than that of ethylene. In freshness management, 1-MCP is effective in blocking ethylene even at very small concentrations (˜100 ppb). However, 1-MCP is a gas difficult to handle and store; it is also flammable above a concentration of 13,300 ppm. As a result, in current agriculture applications, 1-MCP is usually stabilized as a molecular inclusion complex such as the α-cyclodextrin (α-CD) complex to ease handling during storage and transportation. The active ingredient 1-MCP is caged in α-CD and the resulting crystalline complex, is sometimes called High Active Ingredient Product (HAIP). HAIP is typically composed of 100-150 μm needle-like crystals but can be air-milled to a 3-5 μm fine powder if needed. HAIP product can be stored for up to 2 years without loss of 1-MCP at ambient temperature inside a sealed container lined with a moisture barrier. Although the product is more convenient for the application than the 1-MCP gas itself, it still has some disadvantages: (1) it is in a powder form and thus is difficult to handle in the field or in an enclosed space; and (2) it is water-sensitive, and releases 1-MCP gas completely within a short period of time when in contact with water. Upon contact with water or even moisture, 1-MCP gas will be quickly released at a rate which in not compatible with tank use as most of the gas will be lost in the tank headspace before the product had a chance to be sprayed in the field.

In one aspect, provided is a packaging material containing an active volatile compound (for example 1-methylcyclopropene or 1-MCP) prepared in a double encapsulation matrix to extend release of the active volatile compound. The packaging material can be prepared by the following method:

(a) providing an active component comprising a molecular complex of an active volatile compound (for example molecular complex of 1-MCP and α-cyclodextrin); and
(b) generating a polymerizable pre-polymer by cross-linking ethylenic unsaturated groups for encapsulating the active component of (a), thereby resulting a matrix with encapsulated active component;
wherein extended release of the active volatile compound is achieved upon contact of a solvent (for example water or water vapor) as compared to a control molecular complex without encapsulated in the matrix.

In one embodiment, absorbent polymers (for example polyacrylic acid, poly(vinyl alcohol), copolymer of acrylic acid and maleic anhydride, or polyacrylamide/polyacrylic amide) can also be incorporated in the matrix to extend or slow down the release of active volatile compound. In one embodiment, ratio by weight of the absorbent polymers to the acrylate modified polyol is between 1% and 20%.

In another embodiment, the polymerizable pre-polymer comprises an acrylate modified polyol, which can be a reaction product of acrylate and a Dow commercial polyol. In a further embodiment, the polymerizable pre-polymer comprises (meth)acrylic acid esterified polyols, including polyether polyols. In another embodiment, the active component can be a Dow commercial product, e.g. SmartFresh™, HAIP, or EthylBloc™. In another embodiment, the solvent comprises water or water vapor moisture. In another embodiment, the polymer matrix is in a form of bulk gel, powder, or film paste.

In another aspect, provided is a method of preparing a slow release packaging material/matrix for an active volatile compound, comprising,

(a) generating acrylate modified polyols by reacting polyols with at least one hydroxyl group with acrylic acid (AA) or methacrylic acid (MAA);
(b) dispersing a molecular complex of an active volatile compound (for example a molecular complex of 1-MCP and α-cyclodextrin complex) into the acrylate modified polyols, thereby forming a slurry of the molecular complex and the acrylate modified polyols; and
(c) polymerizing the slurry into a network matrix by heat or radiation;
wherein extended release of the active volatile compound is achieved upon contact of a solvent as compared to a control molecular complex without encapsulated in the matrix.

In one embodiment, the steps (b) and (c) are solvent-free. In another embodiment, the network matrix is in a gel form. In another embodiment, the heat is provided by incubation at a temperature between 55° C. to 85° C. In a further embodiment, time of the incubation is from 2 hours to 48 hours. In another embodiment, the radiation does not include ultraviolet (UV) light.

In one embodiment, the slurry is casted onto an existing package film (for example polyethylene or polyvinyl alcohol) and then polymerized into gel to form a coating on the existing package film. In another embodiment, no existing package film is used and the slurry is polymerized into gel without support of another package film/packaging material. In a further embodiment, the slurry is polymerized into a packaging material without support of another package film/packaging material.

The packaging material/matrix prepared based on the disclosed process can have at least one of the following advantages: (1) unique double encapsulation structure of the matrix prevents the initial water penetration upon dilution and extends the release rate over a longer period of time; (2) minimal 1-MCP loss as compared to previous formulations; and (3) the final product appears convenient in use, and the formulation is easy to store and transport.

It is also possible to replace HAIP with other active complex for example SmartFresh™ or EthylBloc® for ethylene inhibitors, which can be encapsulated into the network matrix provided herein.

Polyols are not limited to a Dow product, Voranol 3322. Other Dow Voranol products or related Dow polyether polyols or poly(propylene glycol) (PPGs) with different molecular weight or polyethylene glycols (PEGs) with different molecular weight can be used as the polyols.

Acrylic acids (AA) or methacrylic acids (MAA) can be used to modify polyols via the esterification of AA or MAA with the polyols described herein.

Other alternative cross-linkable systems can be used for the subject invention, for example epoxidized polyols can react with diamines to form a polymer gel. Other examples include polymer gels where isocyanate modified polyols react with diamines or amines; and/or isocyanate modified polyols react with trienthyl citrate.

In one embodiment in the synthesis of acrylic acid modified Voranol 3322, the mole ratio of AA to Voranol 3322 could range from 3:1 to 20:1. In another embodiment in the composition of dispersion of HAIP and acrylic acid modified Voranol 3322 (AM-Voranol 3322), the concentration of HAIP could range from 0.1% to 10% by weight.

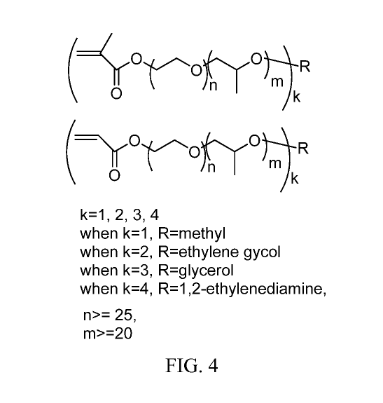

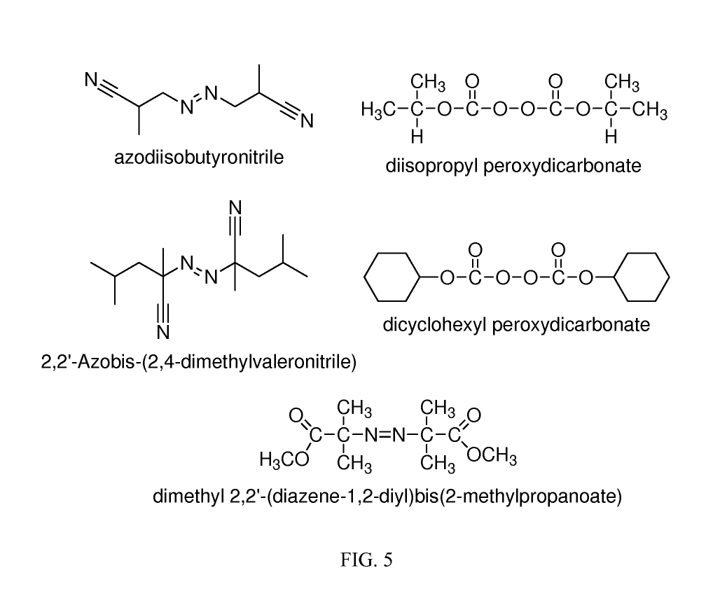

Examples of additional monomers or mixtures thereof are shown in FIG. 4. In some embodiments, initiators are used during polymerization. In a further embodiment, the initiators are selected from the group consisting of azodiisobutyronitrile, diisopropyl peroxydicarbonate, 2′,2′-Azobis-(2,4-dimethylvaleronitrile), dicyclohexyl peroxydicarbonate, dimethyl 2,2′-(diazene-1,2-diyl)bis(2-methylpropanoate), and combinations thereof (also shown in FIG. 5).

In one embodiment, surfactants can be used during or before polymerization. Suitable surfactants include, for example, anionic surfactants, nonionic surfactants, and mixtures thereof. Some suitable anionic surfactants include, but not limited to, sulfates, and the sulfonates. Some suitable nonionic surfactants include, but not limited to, ethoxylates of fatty alcohols, ethoxylates of fatty acids, block copolymer of polyoxyethylene and polyolefin, and mixture thereof.

As used herein, a material is water-insoluble if the amount of that material that can be dissolved in water at 25° C. is 1 gram of material or less per 100 grams of water.

As used herein, when reference is made to a collection of powder particles, the phrase “most or all of the powder particles” means 50% to 100% of the powder particles, by weight based on the total weight of the collection of powder particles.

As used herein, a “solvent compound” is a compound that has boiling point at one atmosphere pressure of between 20° C. and 200° C. and that is liquid at one atmosphere pressure over a range of temperatures that includes 20° C. to 30° C. A “solvent” can be a solvent compound or a mixture of solvents. A non-aqueous solvent can be a solvent that either contains no water or that contains water in an amount of 10% or less by weight based on the weight of the solvent.

As used herein, the phrase “aqueous medium” refers to a composition that is liquid at 25° C. and that contains 75% or more water by weight, based on the weight of the aqueous medium. Ingredients that are dissolved in the aqueous medium are considered to be part of the aqueous medium, but materials that are not dissolved in the aqueous medium are not considered to be part of the aqueous medium. An ingredient is “dissolved” in a liquid if individual molecules of that ingredient are distributed throughout the liquid and are in intimate contact with the molecules of the liquid.

As used herein, when any ratio is said to be X:1 or higher, that ratio is meant to be Y:1, where Y is X or higher. Similarly, when any ratio is said to be R:1 or lower, that ratio is meant to be S:1, where S is R or lower.

The practice of the present invention involves the use of one or more cyclopropene compound. As used herein, a cyclopropene compound is any compound with the formula

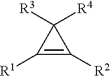

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6. Independently, in any one R group the total number of non-hydrogen atoms is 50 or less. Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups are independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and napthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower; 25° C. or lower; or 15° C. or lower. In another embodiment, a cyclopropene compound can be used that has boiling point at one atmosphere pressure of −100° C. or higher; −50° C. or higher; −25° C. or higher; or 0° C. or higher.

The compositions disclosed herein include at least one molecular encapsulating agent. In preferred embodiments, at least one molecular encapsulating agent encapsulates one or more cyclopropene compound or a portion of one or more cyclopropene compound. A complex that includes a cyclopropene compound molecule or a portion of a cyclopropene compound molecule encapsulated in a molecule of a molecular encapsulating agent is known herein as a “cyclopropene compound complex” or “cyclopropene molecular complex.”

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

The amount of molecular encapsulating agent can usefully be characterized by the ratio of moles of molecular encapsulating agent to moles of cyclopropene compound. In one embodiment, the ratio of moles of molecular encapsulating agent to moles of cyclopropene compound can be 0.1 or larger; 0.2 or larger; 0.5 or larger; or 0.9 or larger. In another embodiment, the ratio of moles of molecular encapsulating agent to moles of cyclopropene compound can be 10 or lower; 5 or lower; 2 or lower; or 1.5 or lower.

Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the molecular encapsulating agent comprises alpha-cyclodextrin, beta-cyclodextrin, gamma-cyclodextrin, or combinations thereof. In a further embodiment, the molecular encapsulating agent comprises alpha-cyclodextrin.

In one embodiment, complex powders may have median particle diameter of 100 micrometers or less; 75 micrometers or less; 50 micrometers or less; or 25 micrometers or less. In another embodiment, complex powders may have median particle diameter of 10 micrometers or less; 7 micrometers or less; or 5 micrometers or less. In another embodiment, complex powders may have median particle diameter of 0.1 micrometer or more; or 0.3 micrometer or more. Median particle diameter may be measured by light diffraction using a commercial instrument such as those manufactured, for example, by Horiba Co. or Malvern Instruments.

In another embodiment, complex powders may have median aspect ratio of 5:1 or lower; 3:1 or lower; or 2:1 or lower. If a complex powder is obtained that has undesirably high median aspect ratio, mechanical means may be used, for example, milling, to reduce the median aspect ratio to a desirable value.

The amount of carrier composition provided in the slurry may be characterized by the concentration of cyclopropene compound in the slurry. In one embodiment, suitable slurries may have cyclopropene compound concentration, in units of milligrams of cyclopropene compound per liter of slurry, of 2 or higher; 5 or higher; or 10 or higher. In another embodiment, suitable slurries may have cyclopropene compound concentration, in units of milligrams of cyclopropene compound per liter of slurry, of 1000 or lower; 500 or lower; or 200 or lower.

The slurry may optionally include one or more adjuvants, for example and without limitation, one or more metal complexing agent, alcohol, extender, pigment, filler, binder, plasticizer, lubricant, wetting agent, spreading agent, dispersing agent, sticker, adhesive, defoamer, thickener, transport agent, emulsifying agent or mixtures thereof. Some of such adjuvants commonly used in the art can be found in the John W. McCutcheon, Inc. publication Detergents and Emulsifiers, Annual, Allured Publishing Company, Ridgewood, N.J., U.S.A. Examples of metal-complexing agents, if used, include chelating agents. Examples of alcohols, if used, include alkyl alcohols with 4 or fewer carbon atoms.

In some embodiments, the at least one active volatile compound may comprise one or more plant growth regulators. As used herein, the phase “plant growth regulator” includes, but not limited to, ethylene, cyclopropenes, glyphosate, glufosinate, and 2,4-D. Other suitable plant growth regulators have been disclosed in International Patent Application Publication WO 2008/071714A1, which is incorporated by reference in its entirety.

### EXAMPLES

### Example 1

### Sample Preparation and Testing

Control test 1: HAIP (1-MCP/α-CD molecular complex) is obtained from AgroFresh Inc., where 1-MCP is 4.5 wt % based on the total weight of the sample HAIP. Three experiments are repeated to confirm the release of 1-MCP for HAIP by immersion into water. 20 milligrams of HAIP are added into each of three 250 ml headspace bottles. 2 ml of water is added into the bottles by syringe, and then the bottles are mechanically shaken for two hours. The headspace of each of the three bottles analyzed after 2 hours and about 250 μl of headspace volume is sampled for analysis. In each sampling, the amount of 1-MCP released from HAIP is quantified by gas chromatography wherein cis-2-butene is used as internal standard. The data for these three samples are shown in Table 1.

TABLE 1
Headspace concentration of 1-MCP and release
percent of 1-MCP relative to the total value

| Sample # | 1-MCP ppm (v/v) | Release percent (%) |
|---|---|---|
| Sample 1-1 | 1707.9 | 99.8 |
| Sample 1-2 | 1768.6 | 99.6 |
| Sample 1-3 | 1791.1 | 100 |

Control test 2: Saturated salt solution is employed to produce the constant relative humidity of the headspace bottle at constant temperatures. For example, saturated potassium nitrate (KNO₃) solution produced 95% humidity of the headspace bottle at 4° C. Saturated potassium chloride (KCl) solution produced 88% humidity of the headspace bottle at 4° C.

TABLE 2
Headspace concentration of 1-MCP and release
percent of 1-MCP relative to total value

| | 1-MCP | Release |
|---|---|---|
| Hours | ppm (v/v) | percent (%) |
| 1 | 30.3 | 1.9 |
| 5 | 123.9 | 7.8 |
| 24 | 133.6 | 8.4 |
| 96 | 142.7 | 9.0 |
| 168 | 146.3 | 9.2 |
| 264 | 148.8 | 9.4 |
| 336 | 152.0 | 9.6 |

20 mg HAIP is placed on the top of a headspace bottle which is supported by a plastic. The bottle is sealed with Mininert valve with a septum. 3 ml potassium nitrate is injected into the bottle. Care is taken so that the solution did not contact the sample directly. The bottle is placed in a refrigerator at 4° C. The headspace of each bottle is analyzed at 1, 5, 24, 96, 168, 264, and 336 hours after injection of water wherein about 250 μl of headspace volume is removed for each analysis. In each sampling, the amount of 1-MCP is quantified by gas chromatography wherein cis-2-butene is used as internal standard. Table 2 shows the headspace concentration of 1-MCP and the release percent of 1-MCP relative to total value.

Control test 3: 20 mg of HAIP is placed in a 54° C. oven for 14 days. Then the ageing sample is added into a 250 ml headspace bottle. 2 ml of water is added into the bottle by a syringe, and then the bottle is placed on a mechanical shaker and mixed vigorously for at least 24 hours. After the shaking, 250 μl of the headspace gas is sampled and analyzed at 2, 24 hours by gas chromatography. The headspace concentration of 1-MCP is quantified with cis-2-butene as the internal standard. It showed that 70% of the 1-MCP is still retained for after the aging, which means that 30% of 1-MCP can be lost during the aging for the HAIP.

### Example 2

### Additional Test Sample

Sample 2-1 (test sample)—Synthesis of Acrylate modified Voranol 3322: 75 g Voranol 3322 and 24 g acrylic acid are added into a 500 ml round bottle followed with the addition of 150 ml Toluene, then 0.5 g hydroquinone as the inhibitor and 2 g p-Toluenesulfonic acid as the catalyst are also added into above solution. A Dean and Stark apparatus, water separator is fitted on the top of the round bottle before the reflux of toluene. The mixture is stirred under a magnetic stick at an oil bathed pot. The temperature of the oil is heated to around 130° C. (the boiling point of toluene is about 110° C.) till the toluene is refluxed into the Dean and Stark apparatus. In the beginning, non-transparent solution is refluxed and collected in the water separator. Then, phase separation is also found in the collecting tube and the bottom is water. The water is removed in time in order to prevent back-flow into the reactor. The refluxing reaction can last 24 hours.

Most of toluene is removed under rotary evaporation. 20 ml DI-water is added into above coarse solution and is shaken vigorously. 20 g sodium carbonate is added and still shaken vigorously to make sure that sodium carbonate reacted with the un-reacted acrylic acid. 20 g sodium sulfate is added into above slurry after that to dry. Then the slurry is kept for some time and the separation happened.

The above solution of the slurry is purified via chromatography separation, which is filled with neutral alumina oxide. Ethyl acetate is used as the fluent solvent. Most of solvent for the filtrate is removed under rotary evaporation. The trace solvent is removed by using vacuum pump. 60 g final acrylate modified Voranol 3322 is obtained.

Synthesis of gel formulation: 0.1 g HAIP and 0.1 g 2,2′-Azobis-(2,4-dimethylvaleronitrile)(ABVN) are added into 3 g acrylate modified Voranol 3322. The mixture is blended well via mechanical stirrer at 1500 rpm to form homogeneous slurry. Care is taken so that the moisture and water are not involved into the reaction during the whole reaction. The slurry is reacted in a vacuum oven at 70° C. for 4 hours. Gel formulation is ground into powder by an IKA® A11 Basic grinder. The average particle size of the powder is around 1 mm.

Full release of the test sample: 250 mg of Sample 2-1 is added into a 250 ml headspace bottle. The bottle is sealed with a Mininert with a septum. 3 ml of water is added into the bottle by a syringe, and then the bottle is placed on a mechanical shaker and mixed vigorously for at least 24 hours. After the shaking, 250 μl of the headspace gas is sampled and analyzed at 1, 24 hours by gas chromatography. The headspace concentration of 1-MCP is quantified using cis-2-butene as the internal standard. Table 3 shows the data of the headspace concentration of 1-MCP and the release percent of 1-MCP relative to total value. If some 1-MCP is lost during the preparation of gel formulation, 1-MCP is not 100% released by immersion into water.

TABLE 3
Headspace concentration of 1-MCP and release
percent of 1-MCP relative to total value

| | 1-MCP | Release |
|---|---|---|
| Hours | ppm (v/v) | percent (%) |
| 1 | 285.4 | 48.4 |
| 24 | 610.2 | 100 |

Slow release of the test sample: 250 mg of Sample 2-1 is placed on the top of a headspace bottle which is supported by a plastic. The bottle is sealed with a Mininert with a septum. 3 ml potassium nitrate (KNO₃) is injected into the bottle. Care is taken so that the solution did not contact the sample directly. The bottle is placed in a refrigerator at 4° C. The headspace gas of the bottle is analyzed at 2, 5, 24, 96, 168, 240, and 336 hours after injection of water wherein about 250 μl of headspace volume is removed for each analysis. In each sampling, the amount of 1-MCP is quantified by gas chromatography wherein cis-2-butene is used as internal standard. Table 4 shows the headspace concentration of 1-MCP and the release percent of 1-MCP relative to total value.

Stability of the gel formulation: 250 mg of Sample 2-1 is placed in a 54° C. oven for 14 days. Then the aging sample is added into a 250 ml headspace bottle. 3 ml of water is added into the bottle by a syringe, and then the bottle is placed on a mechanical shaker and mixed vigorously for at least 24 hours. After the shaking, 250 μl of the headspace gas is sampled and analyzed by gas chromatography. The headspace concentration of 1-MCP is quantified with cis-2-butene as the internal standard. Table 5 shows the loss of 1-MCP during the storage of 14 days at 54° C.

TABLE 4
Headspace concentration of 1-MCP and release
percent of 1-MCP relative to total value for Sample 2-1

| Hours | 1-MCP ppm (v/v) | Release percent (%) |
|---|---|---|
| 2 | 15.1 | 2.6 |
| 5 | 38.1 | 6.6 |
| 24 | 88.4 | 15.2 |
| 96 | 206.2 | 35.5 |
| 168 | 242.4 | 41.8 |
| 240 | 271.7 | 46.8 |
| 336 | 294.2 | 50.7 |

Little 1-MCP is lost during the preparation of gel formulation. 1-MCP release can be extended in the ˜90% humidity at least for 15 days, and 1-MCP release can still be observed after 15 days in some cases. In order to adjust the release time of 1-MCP in the humidity, water absorbent polymers can be used. About 7% loss of 1-MCP for the sample after aging in the 54° C. oven and 14 days show good storage stability. Thus Sample 2-1 has better storage stability than the pure HAIP, since 30% of 1-MCP is lost for the HAIP after the aging.

TABLE 5
Release percent of 1-MCP relative to
total value before or after aging

| Aging | Release percent (%) |
|---|---|
| No | 99.1 |
| 14 days, 54° C. | 92.3 |

### Example 3

### Additional Test Samples Using Different Polyols

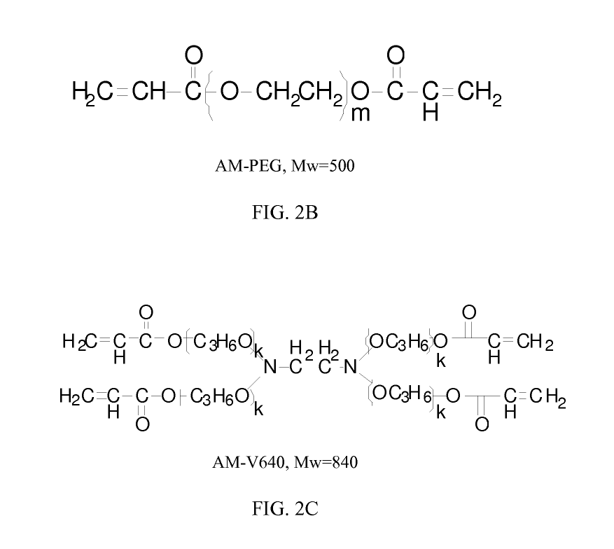

Three different acrylate modified polyols are used as the monomers, including polyethylene glycol 350 monoacrylate (MPEGMA), acrylate modified polyethylene glycol 400 (AM-PEG), and acrylate modified Voranol RA 640 (AM-V640). The structures of these three monomers are shown in FIG. 2 A-C.

The gel formulations are synthesized/polymerized with different acrylate modified polyols as described herein, and the gel formulations synthesized from these three monomers are designated as GF-MPEGMA, GF-(AM-PEG), and GF-(AM-V640) respectively. The 1-MCP release profiles are carried out in 95% humidity at 4° C. for all of the gel formulations. Table 6 shows the headspace concentration of 1-MCP and the release percent of 1-MCP relative to total value for the gel formulation synthesized by all of the acrylate modified polyols in this Example.

TABLE 6
Headspace concentration of 1-MCP and release percent of 1-MCP relative
to total value

| | GF-MPEGMA | | GF-(AM-PEG) | | GF-(AM-V640) | |
|---|---|---|---|---|---|---|
| | | Release | | Release | | Release |
| | 1-MCP | percent | 1-MCP | percent | 1-MCP | percent |
| Hours | ppm (v/v) | (%) | ppm (v/v) | (%) | ppm (v/v) | (%) |
| 0.5 | 1.4 | 0.2 | 0.9 | 0.2 | 6.4 | 1.5 |
| 2 | 15.1 | 2.6 | 9.0 | 1.6 | 19.0 | 4.4 |
| 5 | 43.8 | 7.6 | 26.4 | 4.6 | 47.2 | 10.8 |
| 24 | 113.5 | 19.6 | 61.1 | 10.6 | 79.9 | 18.4 |
| 48 | 115.0 | 19.9 | 84.2 | 14.7 | 92.3 | 21.2 |
| 72 | — | — | 96.5 | 16.8 | — | — |
| 96 | — | — | — | — | 103.8 | 23.9 |
| 124 | 114.8 | 19.8 | — | — | — | — |
| 168 | — | — | 133.0 | 23.2 | 112.7 | 25.9 |
| 336 | — | — | 165.8 | 28.7 | 122.6 | 28.2 |

Thus, various acrylate modified polyols can be used as the raw materials to synthesize the gel formulation. 1-MCP release can be extended for all of the gel formulations tested. But only ˜30% of 1-MCP is released in 336 hours (14 days), which appears lower release than the gel formulation synthesized by acrylate modified Voranol 3322.

### Example 4

### Test Samples with Water Absorbent Polymers

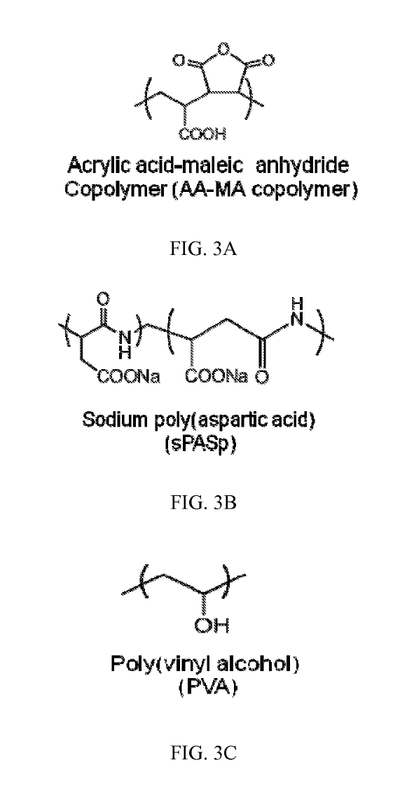

Three water absorbent polymers, including acrylic acid-maleic anhydride copolymer (AA-MA copolymer), sodium poly(aspartic acid)(sPASp), and poly(vinyl alcohol)(PVA), are used as the additives to enhance the release of 1-MCP for the gel formulation. Structures of these three water absorbent polymers are shown in FIG. 3 A-C.

Sample 4-1: 0.1 g HAIP, 0.1 g 2,2′-Azobis-(2,4-dimethylvaleronitrile)(ABVN), and 0.15 g AA-MA copolymer (5 wt % based on the total gel formulation) are added into 2.7 g acrylate modified Voranol 3322. The mixture is blended well via mechanical stirrer at 1500 rpm to form homogeneous slurry. Care is taken so that the moisture and water are not involved into the reaction during the whole reaction. The slurry is reacted in a vacuum oven at 70° C. for 4 hours. Gel formulation is got and ground into powder by an IKA® A11 Basic grinder. The average particle size of the powder is around 1 mm. The gel formulation having 20 wt % AA-MA copolymer is synthesized according to the above procedures. And the formulation is also ground into powder with the particle size around 1 mm.

TABLE 7
Headspace concentration of 1-MCP and release
percent of 1-MCP relative to total value for Sample 4-1

| | 5 wt % AA-MA copolymer | | 20 wt % AA-MA copolymer | |
|---|---|---|---|---|
| | 1-MCP | Release | 1-MCP | Release |
| Hours | ppm (v/v) | percent (%) | ppm (v/v) | percent (%) |
| 0.5 | 28.7 | 5.5 | 0.9 | 0.2 |
| 2 | — | — | 2.5 | 0.6 |
| 5 | 73.8 | 14.1 | 14.1 | 3.1 |
| 24 | 104.5 | 19.9 | 115.7 | 25.8 |
| 48 | 123.8 | 23.6 | 255.3 | 56.9 |
| 96 | 200.4 | 38.2 | 376.3 | 83.8 |
| 168 | 232.4 | 44.3 | 400.3 | 89.2 |

3 ml saturated potassium nitrate (KNO₃) is used to produce the 95% humidity at 4° C. for the headspace bottle. The 1-MCP release profiles in 95% humidity at 4° C. for the gel formulations with 5 wt % and 20 wt % AA-MA copolymer are conducted. The results are shown in Table 7.

### Example 5

### Additional Test Samples with Water Absorbent Polymers

Three water absorbent polymers, AA-MA copolymer, sPASp and PVA are used as the additives to enhance the release of 1-MCP for the gel formulation.

Sample 5-1: 0.1 g HAIP, 0.1 g 2,2′-Azobis-(2,4-dimethylvaleronitrile)(ABVN), and 0.3 g water absorbent polymers (three different water absorbent polymers are used as the additives relatively, which the content of additive is fixed at 10 wt % based on the total gel formulation) are added into 2.5 g acrylate modified Voranol 3322. The mixture is blended well via mechanical stirrer at 1500 rpm to form homogeneous slurry. Care is taken so that the moisture and water are not involved into the reaction during the whole reaction. The slurry is reacted in a vacuum oven at 70° C. for 4 hours. Gel formulation is got and ground into powder by an IKA® A11 Basic grinder. The average particle size of the powder is around 1 mm.

TABLE 8
Headspace concentration of 1-MCP and release percent of 1-MCP relative
to total value for Sample 5-1

| | 10 wt % AA-MA | | 10 wt % | | | |
|---|---|---|---|---|---|---|
| | copolymer | | sPASp | | 10 wt % PVA | |
| | | Release | 1-MCP | Release | 1-MCP | Release |
| | 1-MCP ppm | percent | ppm | percent | ppm | percent |
| Hours | (v/v) | (%) | (v/v) | (%) | (v/v) | (%) |
| 0.5 | — | — | 0 | 0 | 0 | 0 |
| 2 | 0 | 0 | 0 | 0 | — | — |
| 5 | — | — | 0 | 0 | 0 | 0 |
| 6 | — | — | — | — | 6.2 | 1.4 |
| 24 | 15.4 | 3.4 | 35.7 | 7.8 | 135.8 | 30.6 |
| 48 | 28.7 | 6.5 | 67.2 | 14.7 | 214.6 | 48.5 |
| 96 | — | — | 115.3 | 25.2 | 311.2 | 70.3 |
| 168 | 83.7 | 19.0 | — | — | 362.4 | 81.8 |
| 192 | — | — | 138.2 | 30.3 | — | — |
| 264 | 124.0 | 28.1 | — | — | 394.2 | 89.0 |
| 336 | — | — | 202.1 | 44.3 | — | — |
| 384 | 140.8 | 32.0 | — | — | — | — |

3 ml saturated potassium chloride (KCl) is used to produce the 88% humidity at 4° C. for the headspace bottle. The 1-MCP release profiles in 88% humidity at 4° C. for the gel formulations with 10 wt % water absorbent polymers (AA-MA copolymer, sPASp or PVA) are conducted. The results are shown in Table 8.

Stability of the gel formulation: 250 mg of each powder sample is placed in a 54° C. oven for 14 days. Then the aging sample is added into a 250 ml headspace bottle. 3 ml of water is added into each bottle by a syringe, and then each bottle is placed on a mechanical shaker and mixed vigorously for at least 24 hours. After the shaking, 250 μl of the headspace gas is sampled and analyzed by gas chromatography. The headspace concentration of 1-MCP is quantified with cis-2-butene as the internal standard. Table 9 shows the loss of 1-MCP during the storage of 14 days at 54° C.

The water absorbent polymers can alter release profiles of 1-MCP depending on polymers or the content of polymers in the gel formulation. None of 1-MCP is lost during the preparation of gel formulation regardless water absorbent polymers are involved or not. And little of 1-MCP is lost after the aging at 54° C. oven and 14 days for these gel formulations incorporating 10 wt % of water absorbent polymers.

TABLE 9
Release percent of 1-MCP relative to
total value before or after aging

| | 1-wt % AA-MA | 10 wt % | 10 wt % |
|---|---|---|---|
| Samples | copolymer | sPASp | PVA |
| Before aging | 99.4% | 100.0% | 99.8% |
| After aging at 14 | 98.0% | 92.5% | 96.2% |
| days, 54° C. | | | |

1. A method of preparing a gel matrix, comprising,
(a) providing an active component comprising a molecular complex of an active volatile compound; and;
(b) generating a polymerizable pre-polymer by cross-linking ethylenic unsaturated groups for encapsulating the active component of (a), thereby resulting a matrix with encapsulated active component; and
wherein extended release of the active volatile compound is achieved upon contact of a solvent as compared to a control molecular complex without encapsulated in the matrix.

2. The method of claim 1, wherein the active volatile compound comprises a cyclopropene compound and the molecular complex comprises the cyclopropene compound encapsulated by a molecular encapsulating agent.

3. The method of claim 2, wherein the cyclopropene compound is of the formula: 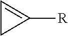
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

4. The method of claim 3, wherein R is C₁₋₈ alkyl.

5. The method of claim 3, wherein R is methyl.

6. The method of claim 2, wherein the cyclopropene compound is of the formula: 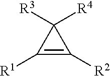
wherein R¹ is a substituted or unsubstituted C₁-C₄ alkyl, C₁-C₄ alkenyl, C₁-C₄ alkynyl, C₁-C₄ cycloalkyl, cycloalkylalkyl, phenyl, or napthyl group; and R², R³, and R⁴ are hydrogen.

7. The method of claim 2, wherein the cyclopropene compound comprises 1-methylcyclopropene (1-MCP).

8. The method of claim 2, wherein the molecular encapsulating agent comprises alpha-cyclodextrin, beta-cyclodextrin, gamma-cyclodextrin, or combinations thereof.

9. The method of claim 2, wherein the molecular encapsulating agent comprises alpha-cyclodextrin.

10. The method of claim 1, further comprising adding at least one absorbent polymer to the matrix.

11. The method of claim 10, wherein the absorbent polymer is selected from the group consisting of poly(vinyl alcohol)(PVA), polyacrylic acid, polyacrylamide, copolymer of acrylic acid and maleic anhydride (AA-MA copolymer), sodium poly(aspartic acid) (sPASp) and combinations thereof.

12. The method of claim 1, wherein the polymerizable pre-polymer comprises an acrylate modified polyol.

13. The method of claim 12, wherein the polyol is modified using Acrylic acids (AA), methacrylic acids (MAA), or combinations thereof.

14. The method of claim 13, wherein mole ratio of AA to polyol is between 3:1 and 20:1.

15. The method of claim 12, wherein ratio by weight of the active component to the acrylate modified polyol is between 0.1% and 10%.

16. The method of claim 1, further comprising adding at least one initiator before polymerization.

17. The method of claim 16, wherein the initiator is selected from the group consisting of azodiisobutyronitrile, diisopropyl peroxydicarbonate, 2′,2′-Azobis-(2,4-dimethylvaleronitrile), dicyclohexyl peroxydicarbonate, dimethyl 2,2′-(diazene-1,2-diyl)bis(2-methylpropanoate), and combinations thereof.

18. A gel matrix prepared according to the method of claim 1.

19. (canceled)

20. A method for preparing slow release packaging material/gel matrix, comprising,
(a) generating acrylate modified polyols by reacting polyols with at least one hydroxyl group with acrylic acid (AA) or methacrylic acid (MAA);
(b) dispersing a molecular complex of an active volatile compound into the acrylate modified polyols, thereby forming a slurry of the molecular complex and the acrylate modified polyols; and
(c) polymerizing the slurry into a network matrix by heat or radiation;
wherein extended release of the active volatile compound is achieved upon contact of a solvent as compared to a control molecular complex without encapsulated in the matrix.

21. The method of claim 20, wherein the steps (b) and (c) are solvent-free.

22.-40. (canceled)
